(19) United States
(12) Patent Application Publication
(10) Pub. No.: US 2022/0018554 A1
(43) Pub. Date: Jan. 20, 2022

(54) METHOD(S) FOR CHANGING CONCENTRATION OF A SOLUTE WITHIN A SOLUTION

(71) Applicant: Mrinal JAGIRDAR, Surat (IN)

(72) Inventor: Mrinal JAGIRDAR, Surat (IN)

(21) Appl. No.: 17/419,086

(22) PCT Filed: Sep. 15, 2019
(86) PCT No.: PCT/IN2019/050673

§ 371 Date: Jun. 28, 2021

(30) Foreign Application Priority Data
Dec. 31, 2018 (IN) 201821050135

(51) Int. Cl. F24F 3/14; F24F 11/00; F24F 11/30

(52) U.S. Cl. CPC F24F 3/1417; F24F 2003/1458; F24F 11/30; F24F 11/0008

(57) ABSTRACT

A method(s) (600, 1100) for changing concentration of a solute within a solution is disclosed. The method (600) includes receiving a first stream of the solution at a state Dᵢₙ by a first heat and mass exchanger HMX1 and a second stream of the solution by a second heat and 5 mass exchanger HMX2. The method (600) includes processing the first stream of the solution by the HMX1 to generate a first dilute stream of the solution at a state Dₒᵤₜ. Further, the method (600) includes processing the second stream of the solution by the HMX2 to generate a first concentrate stream of the solution at a state Rout. The method (600) includes directing, at the initial phase, the first dilute stream of the solution from the processing unit to a first heat and mass exchanger 0 HMX1-n of a successive processing unit. The method (600) also includes receiving a first stream of the solution at a state Dᵢₙ₋ₙ by a second heat and mass exchanger HMX2-n.

### FIELD OF THE INVENTION

The present invention relates to methods for changing concentration of a solute within a solution.

### BACKGROUND

Maintaining controlled humidity levels for various applications is extremely vital in modern times, be it for thermal comfort of indoor occupants, data-centres, power-plants, manufacturing, chemical industry, oil & gas industry, etc. Controlling humidity, especially reducing it (the process is known as dehumidification) usually consumes a very substantial amount of energy. Most often, the vapour compression refrigeration cycle (VCRS) is used to achieve dehumidification. In certain applications where deep dehumidification and/or if waste-heat at moderately high temperature (>80° C.) is available, desiccant wheels are sometime used. However, desiccant wheels have had limited success due to (i) difficulty availing waste-heat source (at reasonably high temperature) in most applications (ii) the sensible heating of desiccant during dehumidification reducing its capacity to adsorb moisture. In cognizance of these limitations, in one of the existing implementations, cross-cooled desiccant dehumidifiers are employed for performing dehumidification process. The cross-cooled desiccant dehumidifiers usually consist of alternating desiccant coated working air channels and cooling air channels in a cross-flow arrangement. Such dehumidifiers enable simultaneous dehumidification as well as adsorption heat rejection which result in better dehumidification performance. In another existing implementation, solid or liquid desiccant based mass-exchangers with internal heating/cooling may be employed for performing dehumidification process and humidification process. In such mass-exchangers, over and above the air-streams that are directly involved in heat and mass transfer (dehumidification and regeneration), there are two more streams (hot-fluid and cool-fluid) that participate only in heat transfer (not mass transfer). During dehumidification, the cool-fluid takes up the sorption heat while during regeneration, the hot-fluid supplies the sorption heat.

While for some applications dehumidification is important, for others, humidification is vital. A substantial land-mass of the earth is covered with arid and semi-arid regions where humidity levels in the ambient air insufficient for comfort of the people; moreover, the scarcity of water makes life quite difficult. Generally, humidifiers utilize water to increase the humidity of air, this air is then blown into indoor-spaces for thermal comfort of occupants. As far as water scarcity is concerned, some of the conventional solutions include usage of ground-water, transport of water from sweet-water rich regions to water-scarce regions, desalination, etc. Often, these solutions may be impractical or expensive. Hence, researchers have overtime, investigated the possibility of extracting water from moisture in the air. Conventional atmospheric water-harvesters or Atmospheric Water Generators (AWGs) utilize the vapour compression refrigeration cycle to cool a coil below the dew point temperature of the ambient air. This can be expensive, moreover, for regions that are dry (especially with sub-zero dew-point temperatures), this may not be practical. Therefore, there is a need for a method to perform humidification and dehumidification process by changing concentration of a solute within a solution.

### SUMMARY

This summary is provided to introduce a selection of concepts, in a simplified format, that are further described in the detailed description of the invention. This summary is neither intended to identify key or essential inventive concepts of the invention and nor is it intended for determining the scope of the invention.

In an embodiment of the present disclosure, a method for changing concentration of a solute within a solution is disclosed. The method includes receiving a first stream of the solution at a state Dᵢₙ by a first heat and mass exchanger HMX1 of a processing unit from among a plurality of processing units and a second concentrate stream of the solution at the state Rᵢₙ by a second heat and mass exchanger HMX2 of the processing unit. Further, the method includes processing the first stream of the solution by the HMX1 to generate a first dilute stream of the solution at a state Dₒᵤₜ. The HMX1 includes a first desiccant which absorbs a first amount of the solute from the first stream of the solution at an initial phase.

The method also includes processing, at the initial phase, the second stream of the solution by the HMX2 to generate a first concentrate stream of the solution at a state Rout. The HMX2 includes a second desiccant which releases a second amount of the solute within the second stream of the solution at the initial phase. The method includes directing, at the initial phase, the first dilute stream of the solution at the state Dₒᵤₜ from the processing unit by a first heat and mass exchanger HMX1-n of a successive processing unit from among the plurality of processing units. Further, the method includes processing, at the initial phase, the first dilute stream of the solution by the HMX1-n of the successive processing unit to generate a concentrate stream of the solution at a state Rout-n. Further, the method includes receiving a first stream of the solution at a state Dᵢₙ₋ₙ by a second heat and mass exchanger HMX2-n of the successive processing unit. Furthermore, the method includes processing, at the initial phase, the concentrate stream of the solution by the HMX2-n of the successive processing unit to generate the second dilute stream of the solution at a state Dₒᵤₜ₋ₙ. An amount of the solute within the first dilute stream of the solution at the state Dₒᵤₜ₋ₙ is less than an amount of the solute within the first dilute stream of the solution at the state Dᵢₙ.

To further clarify advantages and features of the present invention, a more particular description of the invention will be rendered by reference to specific embodiments thereof, which is illustrated in the appended drawings. It is appreciated that these drawings depict only typical embodiments of the invention and are therefore not to be considered limiting of its scope. The invention will be described and explained with additional specificity and detail with the accompanying drawings.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 illustrates a schematic view of a system for changing concentration of a solute within a solution, according to an embodiment of the present disclosure;

FIG. 2 illustrates the system implementing a method for changing concentration of a solvent within a solution by diluting concentration of the solute within the solution, according to an embodiment of the present disclosure;

FIG. 3 illustrates the system implementing the method for changing concentration of the solvent within the solution by diluting concentration of the solute within the solution, according to another embodiment of the present disclosure;

FIG. 4a illustrates a block diagram of a processing unit of the system implementing the method for changing concentration of the solvent within the solution by diluting concentration of the solute within the solution, according to an embodiment of the present disclosure;

FIG. 4b illustrates a block diagram of a processing unit of the system implementing the method for changing concentration of the solvent within the solution by diluting concentration of the solute within the solution, according to another embodiment of the present disclosure;

FIG. 4c illustrates a block diagram of a processing unit of the system implementing the method for changing concentration of the solvent within the solution by diluting concentration of the solute within the solution, according to yet another embodiment of the present disclosure;

FIG. 4d illustrates a block diagram of a processing unit of the system implementing the method for changing concentration of the solvent within the solution by diluting concentration of the solute within the solution, according to another embodiment of the present disclosure;

FIG. 5 illustrates a block diagram of a processing unit of the system implementing the method for changing concentration of the solvent within the solution by diluting concentration of the solute within the solution, according to another embodiment of the present disclosure;

FIGS. 6a and 6b illustrates a flowchart depicting a method for changing concentration of a solvent within a solution by diluting concentration of the solute within the solution, according to an embodiment of the present disclosure;

FIGS. 7a and 7b illustrates a flowchart depicting a method for changing concentration of a solvent within a solution by diluting concentration of the solute within the solution, according to an embodiment of the present disclosure;

FIG. 8 illustrates the system implementing a method for changing concentration of a solvent within a solution by increasing concentration of the solute within the solution, according to an embodiment of the present disclosure;

FIG. 9 illustrates the system implementing the method for changing concentration of the solvent within the solution by increasing concentration of the solute within the solution, according to an embodiment of the present disclosure;

FIG. 10 illustrates a block diagram of a processing unit of the system implementing the method for changing concentration of the solvent within the solution by increasing concentration of the solute within the solution, according to an embodiment of the present disclosure;

FIG. 11a and Figure lib illustrate a flowchart depicting a method for changing concentration of the solvent within the solution by increasing concentration of the solute within the solution, according to an embodiment of the present disclosure;

FIG. 12a and FIG. 12b illustrate graphical plots depicting variation in specific humidity and temperature of the solution with respect to time duration, according to an embodiment of the present disclosure;

FIG. 12c and FIG. 12d illustrate graphical plots depicting variation in specific humidity and temperature of the solution with respect to time duration, according to an embodiment of the present disclosure;

FIG. 13a illustrates a psychometric plot depicting time-averaged air-states corresponding to the solution entering a first processing unit and exiting from a last processing unit of the system, according to an embodiment of the present disclosure;

FIG. 13b illustrates a psychometric plot depicting time-averaged air-states corresponding to the solution entering a processing unit, according to an embodiment of the present disclosure;

FIG. 14a and FIG. 14b illustrate graphical plots depicting variation in specific humidity and temperature of the solution with respect to time duration, according to an embodiment of the present disclosure;

FIG. 14c and FIG. 14d illustrate graphical plots depicting variation in specific humidity and temperature of the solution with respect to time duration, according to an embodiment of the present disclosure;

FIG. 15a illustrates a psychometric plot depicting time-averaged air-states corresponding to the solution entering a first processing unit and exiting from a last processing unit of the system, according to an embodiment of the present disclosure; and

FIG. 15b illustrates a psychometric plot depicting time-averaged air-states corresponding to the solution entering a processing unit, according to an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present invention. Furthermore, in terms of the construction of the device, one or more components of the device may have been represented in the drawings by conventional symbols, and the drawings may show only those specific details that are pertinent to understanding the embodiments of the present invention so as not to obscure the drawings with details that will be readily apparent to those of ordinary skill in the art having benefit of the description herein.

### DETAILED DESCRIPTION OF FIGURES

For the purpose of promoting an understanding of the principles of the invention, reference will now be made to the embodiment illustrated in the drawings and specific language will be used to describe the same. It will nevertheless be understood that no limitation of the scope of the invention is thereby intended, such alterations and further modifications in the illustrated system, and such further applications of the principles of the invention as illustrated therein being contemplated as would normally occur to one skilled in the art to which the invention relates.

Embodiments of the present invention will be described below in detail with reference to the accompanying drawings.

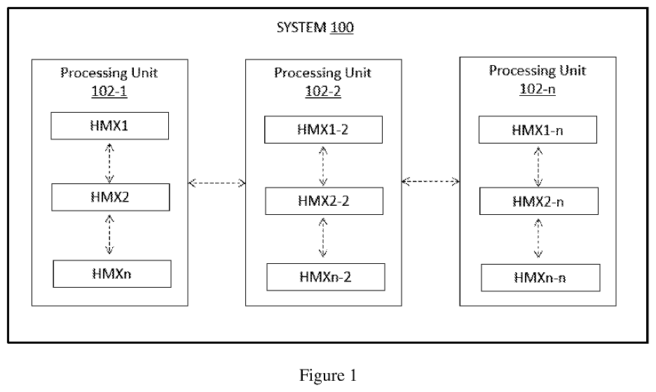

FIG. 1 illustrates a schematic view of a system 100 for changing concentration of a solute within a solution, according to an embodiment of the present disclosure. The system 100 may be employed for using solution with varied concentration of the solute in various applications.

Referring to FIG. 1, the system 100 may include a plurality of processing units 102 in fluid communication with each other. In an embodiment, each of the plurality of processing units 102 may individually be referred to as a processing unit 102-1, a processing unit 102-2, a processing unit 103-2, . . . , and a processing unit 102-n. Further, the plurality of processing unit 102 may interchangeably referred to as the processing units 102, without departing from the scope of the present disclosure.

In the illustrated embodiment, each of the processing unit 102 may include a plurality of heat and mass exchangers HMXs in fluid communication with each other. In an embodiment, the plurality of heat and mass exchangers HMXs may individually referred to as a first heat and mass exchanger HMX1, a second heat and mass exchanger HMX2, third heat and mass exchanger HMX3, . . . , and a nth heat and mass exchanger HMXn, without departing from the scope of the present disclosure. Each of the HMXs may be embodied as (but not limited to) one of the following:

(a) Desiccant coated fin-tube heat exchangers;

(b) Desiccant coated banks of tubes (DCBT);

(c) Heat and mass exchangers found in adsorption/absorption chillers;

(d) Internally cooled desiccant wheel;

(e) Liquids-desiccant based internally cooled/heated mass exchangers;

(f) Fluidized bed reactors;

(g) Fixed-bed reactors;

(h) Spray tower (spray column/spray chamber).

In the illustrated embodiment, the HMX1 and the HMX2 may be configured to change concentration of the solute within the solution. In the present embodiment, the solution and the solute may be embodied as air and moisture, respectively, without departing from the scope of the present disclosure. In such an embodiment, each of the HMXs may be configured to perform humidification process and dehumidification process to change concentration of the solute within the solution. In one embodiment, each of the HMXs may be embodied as one of (a), (b), and (c) units as mentioned above. In such an embodiment, the HMX 1 and the HMX 2 may alternate between dehumidification and regeneration processes periodically. Thus, after some time, air to be dehumidified enters HMX 2 of the processing unit 102-1 at state Din,1 and regeneration air-stream enters HMX 1 of the processing unit 102-1 at state Rin,1 and so on. For instance, at an initial phase, the HMX1 and the HMX2 may perform dehumidification process and humidification process, respectfully. Further, at a subsequent phase, the HMX1 may perform humidification process and the HMX2 may perform dehumidfication process.

In another embodiment, each of the HMXs may be embodied as unit (d) as mentioned earlier. In such an embodiment, the HMX 1 and HMX 2 of the processing unit 102-1 are regions which respectively dehumidify (by absorbing/adsorbing moisture) and humidify (by releasing moisture during regeneration process) air. The HMX1 and the HMX2 of the processing unit 102-2 are sections which respectively humidify and dehumidify air and so on. In yet another embodiment, each of the HMXs may be embodied as unit (e) as mentioned earlier. In such an embodiment, the HMX 1 of the processing unit 102-1 is the conditioner wherein a liquid desiccant absorbs moisture. While, the HMX 2 of the processing unit 102-1 is the regenerator in which a liquid desiccant releases moisture. The HMX 1 and the HMX 2 of the processing unit 102-2 are regenerator and conditioner, respectively, and so on.

Some of the variations possible (but not limited to), as far as the relative directions, magnitude and duration of air and water flow and the number of HMXs are concerned, are:

(a) The air-streams may either be in parallel-flow, cross-flow or counter-flow arrangement.

(b) The pair of air-stream and water-stream may either be in parallel-flow, cross-flow or counter-flow arrangement.

(c) Instead of just HMX1 (read as ‘heat and mass exchanger’) and HMX2, there may be multiple HMXs used to achieve the said purpose (dehumidification of air). Moreover, the number of units undergoing dehumidification and regeneration need not be the same.

(d) The flow rate of air-streams need neither be steady nor does it need not be equal among HMXs. The air-flow rate may vary from one cycle to the next and may vary from one process (dehumidification or regeneration) to the next.

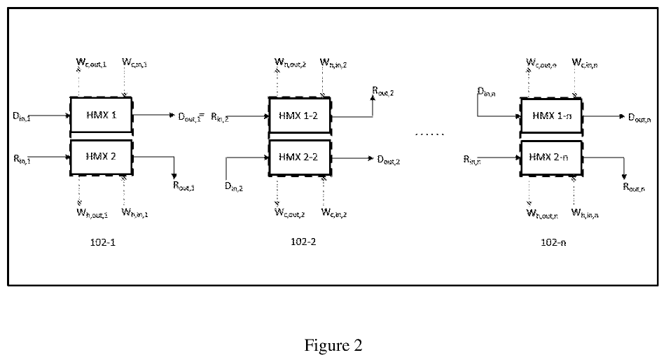

FIG. 2 illustrates the system 100 implementing a method for changing concentration of a solvent within a solution by diluting concentration of the solute within the solution, according to an embodiment of the present disclosure. In an embodiment, the solute and the solution may be embodied as moisture and air, respectively, without departing from the scope of the present disclosure. In such an embodiment, a method of diluting concentration of the solute within the solvent may be referred to as dehumidification process.

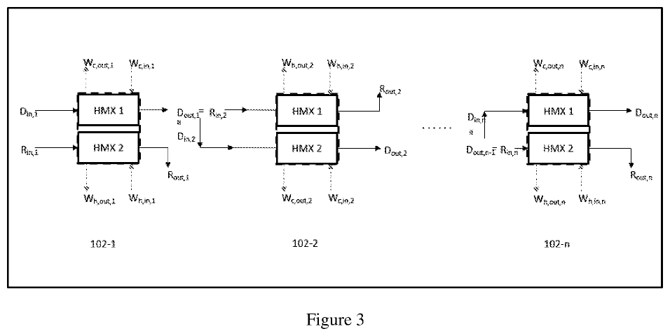

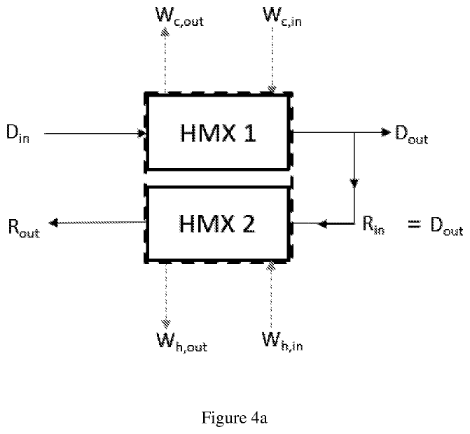

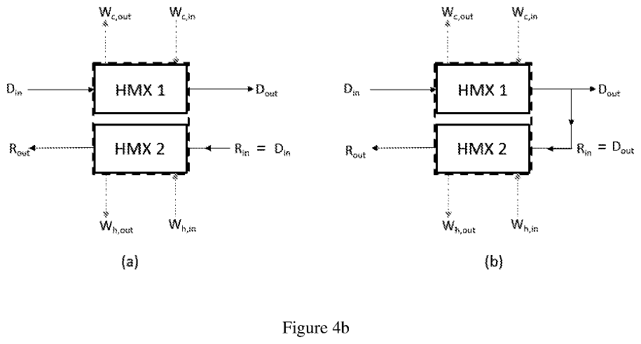

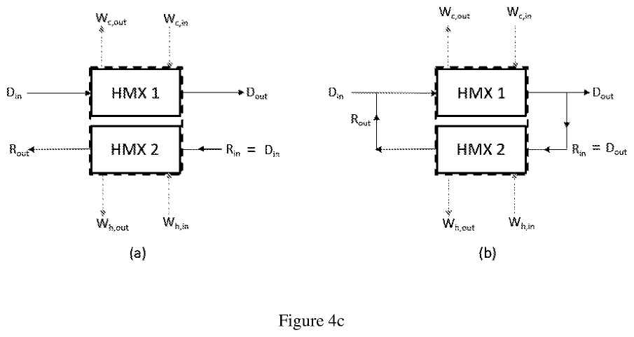

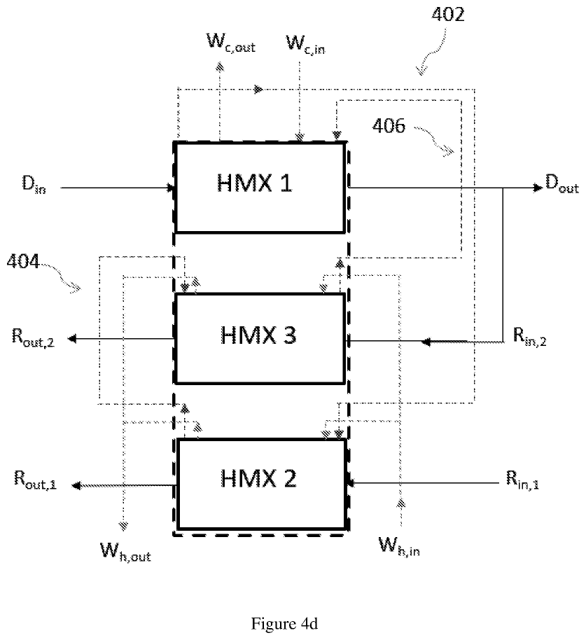

FIG. 2, FIG. 3, FIGS. 4a-4d, FIG. 5, FIGS. 6a-6b, and FIGS. 7a-7b of the present disclosure are explained with respect to dehumidification process. However, it should be appreciated by a person skilled in the art that the present disclosure is equally to other process for changing concentration of solutes within different types of solutions, without departing from the scope of the present disclosure.

In essence, the dehumidification process proposed herein is that the dehumidified air stream, after undergoing dehumidification process (that also involves simultaneous cooling or full/partial heat-rejection), is fully or partly used as the inlet air-stream for regeneration process (which involves simultaneous internal heating). While this air-stream, after regenerating/drying a desiccant matrix may be discarded off, either the part of the dehumidified air stream not utilized for regeneration or the dehumidified air-stream after two or more stages of the aforementioned process is utilized as the useful product. Such product may either be considered as a final product or as an intermediate product, depending on the application.

Referring to FIG. 2, in the illustrated embodiment, the first heat and mass exchanger HMX1 may be configured to receive a first stream of the solution at a state Dᵢₙ, interchangeably referred to as Dᵢₙ₋₁, of the processing unit 102-1 from among a plurality of processing units 102. Further, the second heat and mass exchanger HMX2 the processing unit 102-1 may be configured to receive a second stream of the solution at the state Rᵢₙ, interchangeably referred to as Rᵢₙ₋₁.

Upon receiving the first stream, the HMX1 may process, at an initial phase, the first stream of the solution to generate a first dilute stream of the solution at a state Dₒᵤₜ, interchangeably referred to as Dₒᵤₜ₋₁. The HMX1 may include a first desiccant which absorbs a first amount of the solute from the first stream of the solution at the initial phase. The first desiccant may perform sorption, such as absorption and adsorption, of the solute from the first dilute stream, when a first 15 stream of fluid at state W_{c,in,1} is directed to the HMX1. In an embodiment, the fluid may be embodied as one of water and any other suitable fluid know in the art, without departing from the scope of the present disclosure. The first stream of fluid may absorb heat generated during sorption of the first amount of the solute from the first stream of the solution by the first desiccant. This ensures that the first dilute stream of the solution may not become hot at an outlet of the HMX1.

Subsequently, upon receiving the second stream, the HMX2 may process the second stream of the solution at the state Rᵢₙ₋₁ to generate a first concentrate stream of the solution at a state Rₒᵤₜ, interchangeably referred to as Rₒᵤₜ₋₁. The HMX2 may include a second desiccant which releases a second amount of the solute within the second stream of the solution at the initial phase. In particular, the second stream of the solution may takes up the solute from the second desiccant, when a second stream of fluid at a state W_{h,in,1} is directed to the HMX2.

The second stream of fluid releases heat to increase temperature of the second desiccant which releases the second amount of the solute within the solvent. The second desiccant may perform sorption, such as absorption and adsorption, of the solute from the first dilute stream, when a first stream of fluid at state W_{c,in,1} is directed to the HMX1. The first stream of fluid may absorb heat generated during sorption of the first amount of the solute from the first stream of the solution by the first desiccant. Each of the first desiccant and the second desiccant may be embodied as one of a liquid desiccant, a solid desiccant, and pellets of solid desiccant.

During dehumidification process, the first concentrate stream at the state Rₒᵤₜ₋₁ generated by the HMX2 may be discarded from the system 100. At the initial phase, the HMX1 of the processing unit 102-1 may be configured to supply the first dilute stream of the solution at the state Dₒᵤₜ₋₁ to a first heat and mass exchanger HMX1-n of a successive processing unit 102-n from among the plurality of the processing units 102. In the illustrated embodiment, the HMX1 may be configured to supply the first dilute stream of the solution at the state D_{out,1} to the HMX1-n, where n=2, of a successive processing unit 102-2, interchangeably referred as the processing unit 102-2. The first dilute stream at the state Dₒᵤₜ₋₁ supplied to the HMX1-2 may interchangeably be referred to as the first dilute stream at the state Rᵢₙ₋₂.

Subsequently, at the initial phase, the HMX1-2 may process the first dilute stream of the solution at the state Rᵢₙ₋₂ to generate a concentrate stream of the solution at a state Rₒᵤₜ₋₂. In the illustrated embodiment, the concentrate stream at the state Rₒᵤₜ₋₂ generated by the HMX1-2 may be discarded from the system 100. Further, a second heat and mass exchanger HMX2-2 of the processing unit 102-2 may be configured to receive another stream, i.e., a first stream of the solution at a state Dᵢₙ₋₂. Upon receiving the first stream at the state Dᵢₙ₋₂, the HMX2-2, at the initial phase, may process the first stream of the solution at the state Dᵢₙ₋ₙ to generate a second dilute stream of the solution at a state Dₒᵤₜ₋ₙ. In the illustrated embodiment, the amount of the solute within the second dilute stream of the solution at the state Dₒᵤₜ₋₂ may be less than an amount of the solute within the first dilute stream of the solution at the state Dᵢₙ₋₁. Further, an air stream received from a last processing unit, i.e., the processing unit 102-n, may have a minimum value of specific humidity, and thereby may be used as a final product.

Further, at the subsequent phase, operation of the HMX1-n and the HXM2-n of the subsequent processing unit may be interchanged with each other. In the illustrated embodiment, operation of the HMX1-2 and the HMX2-2 of the processing unit 102-2 may be interchanged with each other. At the subsequent phase, the HMX2-2 of the processing unit 102-2 may receive the first dilute stream of the solution at the state Dₒᵤₜ. Further, the HMX2-2 may process the first dilute stream of the solution to generate the concentrate stream of the solution at the state Rₒᵤₜ₋₂. The HMX2-2 includes a desiccant adapted to release at least a portion from the solute which is being absorbed/adsorbed during the initial phase. Further, the HMX1-2 may receive the first stream of the solution at the state Dᵢₙ₋₂ by the HMX1-2 of the processing unit 102-2. Subsequently, the HMX1-2 may process the second concentrate stream of the solution to generate the second dilute stream of the solution at the state Dₒᵤₜ₋₂. The HMX1-2 includes a desiccant adapted to re-absorb an amount the solute to generate the second dilute stream of the solution. The desiccant of each of the HMX1-2 and the HMX2-2 may be embodied as one of a liquid desiccant, a solid desiccant, and pellets of solid desiccant.

Similarly, at a subsequent phase, operation of the HMX1 and the HMX2 of the processing unit 102 may be interchanged with each other. At the subsequent phase, the first desiccant of the HMX1 releases at least a portion from the first amount of the solute which is being absorbed/adsorbed by the first desiccant, the second desiccant of the HMX2 absorbs an amount of the solute to generate the first dilute stream of the solution.

FIG. 3 illustrates the system implementing the method for changing concentration of the solvent within the solution by reducing concentration of the solute within the solution, according to another embodiment of the present disclosure. For the sake of brevity, features of the system 100 that are already explained in detail in the description of FIG. 1 and FIG. 2 are not explained in detail in the description of FIG. 3.

Referring to FIG. 3, in the illustrated embodiment, the HMX1 may supply at least a portion of the first dilute stream at the state Dₒᵤₜ to the HMX2-n, where n=2, of the successive unit, i.e., the processing unit 102-2. Upon receiving at least the portion of the first dilute stream, the HMX2 may process the received portion to generate the second dilute stream at the state Dₒᵤₜ₋₂.

FIG. 4a illustrates a block diagram of a processing unit of the system implementing the method for changing concentration of the solvent within the solution by diluting concentration of the solute within the solution, according to an embodiment of the present disclosure. Details of the present embodiment are explained with respect to the HMX1 and the HMX2 of the 30 processing unit 102-1.

However, it should be appreciated by a person skilled in the art that the present embodiment can equally be implemented with respect to other processing units 102 of the system 100, without departing from the scope of the present disclosure. For the sake of brevity, features of the system 100 that are already explained in detail in the description of FIG. 1, FIG. 2, and FIG. 3 are not explained in detail in the description of FIG. 4a.

Referring to FIG. 4a, in the illustrated embodiment, the heat and mass exchanger unit HMX1 may be configured to supply at least a portion of the first dilute stream of the solution to the HMX2 of the processing unit 102-1. Subsequently, the HMX2 may process at least a portion of the first dilute stream of the solution to generate a concentrate stream of the solution at the state Rₒᵤₜ. In the illustrated embodiment, the concentrate stream at the state Rₒᵤₜ may be discarded from the system 100. In one embodiment, the first dilute stream at the state Dₒᵤₜ may partially, i.e., at least the portion of stream, be used as a regenerating stream, i.e., Rᵢₙ. In such an embodiment, remaining portion of the first dilute stream may be utilized as a final product from the system 100.

In another embodiment, the first dilute stream at the state Dₒᵤₜ may fully be used as the regeneration stream, i.e., Rᵢₙ. In such an embodiment, the first dilute stream at the state Dₒᵤₜ may fully be used as the regeneration stream, until a periodically steady-state is achieved. However, when the periodically steady-state is achieved, the first dilute stream at the state Dₒᵤₜ may partially be used as the regeneration stream and remaining portion of the first dilute stream may be used as the final product.

FIG. 4b illustrates a block diagram of a processing unit of the system 100 implementing the method for changing concentration of the solvent within the solution by reducing concentration of the solute within the solution, according to another embodiment of the present disclosure. Details of the present embodiment are explained with respect to the HMX1 and the HMX2 of the processing unit 102-1.

However, it should be appreciated by a person skilled in the art that the present embodiment can equally be implemented with respect to other processing units 102 of the system 100, without departing from the scope of the present disclosure. For the sake of brevity, features of the system 100 that are already explained in detail in the description of FIG. 2, FIG. 3, and FIG. 4a are not explained in detail in the description of FIG. 4b.

Referring to FIG. 4b (a), in the illustrated embodiment, the HMX2 may receive ambient air stream, such as the first stream at the state Dᵢₙ, for a first time duration (for example say 50 seconds). Subsequently, the HMX2 may process the first stream at the state Dᵢₙ to generate a concentrate stream, such as the first concentrate stream at the state Rₒᵤₜ. Referring to FIG. 4b (b), after completion of the first time duration, the HMX2 may receive at least a portion of the first dilute stream at the state Dₒᵤₜ which is generated by the HMX1.

In particular, the HMX2 may receive at least the portion of the first dilute stream at the state Dₒᵤₜ for a second time duration (for example say 40 seconds), subsequent to the first time duration. Thereafter, the HMX2 may process the received portion of the first dilute stream at the state Dₒᵤₜ to generate the concentrate stream of the solution at the state Rₒᵤₜ. The second desiccant may increase concentration of the solute in the received portion of the first dilute stream to generate the concentrate stream at the state Rₒᵤₜ. In an embodiment, each of the first time duration and the second time duration may selected based on dilution required in the first dilute stream and required flow-rate of the first dilute stream.

The advantage of the present embodiment is that in initial few seconds, highly dry air (with low RH) is not necessarily required for generating concentrate stream of the solution. However, as time proceeds and desiccant in the HMX becomes drier, much drier air (with low RH) is required, and then dehumidified air, such as the first dilute stream at the state Dₒᵤₜ must be partly redirected towards drying desiccant of the HMX2.

FIG. 4c illustrates a block diagram of a processing unit of the system 100 implementing the method for changing concentration of the solvent within the solution by diluting concentration of the solute within the solution, according to yet another embodiment of the present disclosure. Details of the present embodiment are explained with respect to the HMX1 and the HMX2 of the processing unit 102-1.

However, it should be appreciated by a person skilled in the art that the present embodiment can equally be implemented with respect to other processing units 102 of the system 100, without departing from the scope of the present disclosure. For the sake of brevity, features of the system 100 that are already explained in detail in the description of FIG. 1, FIG. 2, FIG. 3, FIG. 4a, and FIG. 4b are not explained in detail in the description of FIG. 4c.

Referring to FIG. 4c, in the illustrated embodiment, the HMX2 may receive the first concentrate stream at the state Rᵢₙ at the initial phase. The first concentrated stream at the state Rᵢₙ may be embodied as redirected portion of the first dilute stream at the state Dₒᵤₜ which is generated by the HMX1, as explained in description with respect to the FIG. 3b. Further, the HMX2 may process the first concentrate stream of the solution to generate a second concentrate stream of the solution at the state Rₒᵤₜ. Subsequently, the HMX1 may receive at least a portion of the second concentrate stream of the solution from the HMX2. Thereafter, the HMX1 may process the received portion of the second concentrate stream of the solution to generate a dilute stream, such as the first dilute stream, of the solution at the state Dₒᵤₜ.

FIG. 4d illustrates a block diagram of a processing unit of the system 100 implementing the method for changing concentration of the solvent within the solution by reducing concentration of the solute within the solution, according to another embodiment of the present disclosure. Details of the present embodiment are explained with respect to the HMX1, the HMX2, and the HMX3 of the processing unit 102-1.

However, it should be appreciated by a person skilled in the art that the present embodiment can equally be implemented with respect to other processing units 102 of the system 100, without departing from the scope of the present disclosure. For the sake of brevity, features of the system 100 that are already explained in detail in the description of FIG. 1, FIG. 2, FIG. 3, FIG. 4a, FIG. 4b, and FIG. 4c are not explained in detail in the description of FIG. 4d.

Referring to FIG. 4d, in the illustrated embodiment, the HMX1 may be configured to receive a first stream of the solution at the state Dᵢₙ. Further, the HMX1 may process the first stream of the solution to generate a first dilute stream of the solution at the state Dₒᵤₜ. The HMX1 may include a desiccant which absorbs a first amount of the solute from the first stream of the solution. The desiccant may be embodied as one of a liquid desiccant and pellets of solid desiccant.

Further, upon generation of the first dilute stream, the desiccant from the HMX1 may be directed to the HMX2 of the processing unit 102-2, as shown by arrow 402. Subsequently, the HMX2 may receive a concentrate stream of the solution at a state R_{in,1}. The HMX2 may process the concentrate stream of the solution at the state R_{in,1} to generate a first concentrate stream of the solution. The desiccant received by the HMX2 may release at least a first predefined amount of the solute which is being absorbed/adsorbed from the first stream of the solution in the HMX1.

Upon generation of the first concentrate stream, the desiccant may be directed to the HMX3 from the HMX2, as shown by arrow 404. Subsequently, the HMX3 may receive at least a portion of the first dilute stream of the solution at the state Dₒᵤₜ from the HMX1 to the HMX3. The HMX3 may process the at least portion of the first dilute stream of the solution to generate a second concentrate stream of the solution. The desiccant received by the HMX3 from the HMX2 may release at least a second predefined amount of the solute which is being absorbed/adsorbed from the first stream of the solution in the HMX 1. Subsequently, the desiccant may be directed from the HMX3 to the HMX 1 of the processing unit 102-1. Further, the desiccant may re-absorb a second amount of the solute from another stream directed in the HMX1.

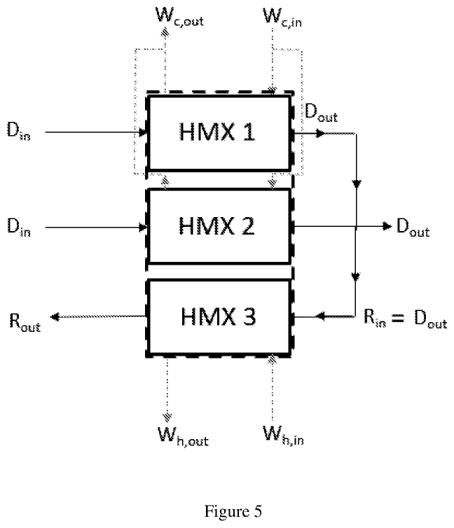

FIG. 5 illustrates a block diagram of a processing unit of the system 100 implementing the method for changing concentration of the solvent within the solution by diluting concentration of the solute within the solution, according to another embodiment of the present disclosure. Details of the present embodiment are explained with respect to the HMX1, the HMX2, and a third heat and mass exchanger HMX3 of the processing unit 102-1.

However, it should be appreciated by a person skilled in the art that the present embodiment can equally be implemented with respect to other processing units 102 of the system 100, without departing from the scope of the present disclosure. For the sake of brevity, features of the system 100 that are already explained in detail in the description of FIG. 1, FIG. 2, FIG. 3, FIG. 4a, FIG. 4b, FIG. 4c, and FIG. 4d are not explained in detail in the description of FIG. 5.

Referring to FIG. 5, in the illustrated embodiment, the processing unit may be employed with three heat and mass exchanger units, i.e., HMX1, HMX2, and HMX3. In such an embodiment, each of the HMX1 and the HMX2 may receive the first stream of the solution at the state Dᵢₙ. Each of the HMX1 and the HMX2 may process the received first stream to generate dilute streams, such as the first dilute stream, at the state Dₒᵤₜ. Subsequently, in an embodiment, the dilute stream from the HMX2 may be directed to HMX1-n or HMX2-n of the successive processing unit. Further, the HMX1 may supply at least a portion of the first dilute stream at the state Dₒᵤₜ of the solution to the HMX3 of the processing unit 102-1.

It may be noted that details regarding system and method for dilution of the solute within the solution is explained with respect to configurations as depicted in FIG. 2, FIG. 3, FIG. 4a, FIG. 4b, FIG. 4c, and FIG. 5. However, it should be appreciated by a person skilled in the art that such details can equally be implemented with respect to other configurations, without departing from the scope of the present disclosure.

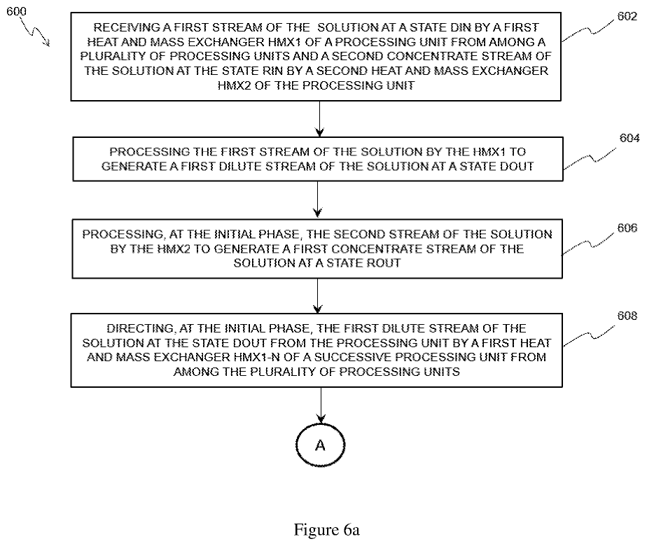

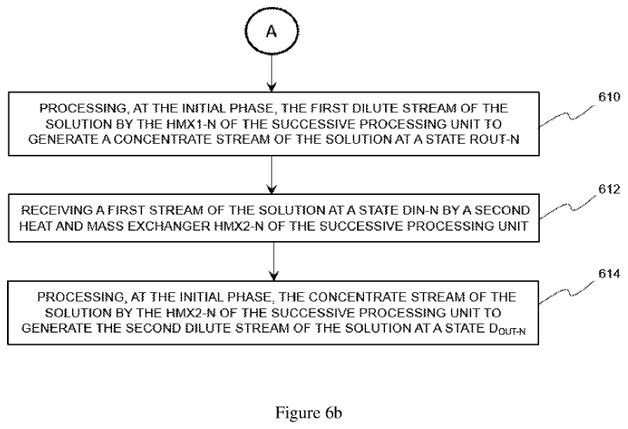

FIGS. 6a and 6b illustrates a flowchart depicting a method 600 for changing concentration of a solvent within a solution by reducing concentration of the solute within the 10 solution, according to an embodiment of the present disclosure. For the sake of brevity, features of the system 100 that are already explained in detail in the description of FIG. 1, FIG. 2, FIG. 3, FIG. 4a, FIG. 4b, FIG. 4c, FIG. 4d, and FIG. 5 are not explained in detail in the description of FIG. 6a and FIG. 6b.

Referring to FIG. 6a, at block 602, the method 600 includes receiving the first stream of the solution at the state Dᵢₙ by the HMX1 of the processing unit 102-1 from among a plurality of processing units 102 and the second stream of the solution at the state Rᵢₙ by the HMX2 of the processing unit 102-1. Further, at block 604, the method 600 includes processing the first stream of the solution by the HMX1 to generate the first dilute stream of the solution at the state Dₒᵤₜ. The HMX1 includes the first desiccant which absorbs the first amount of the solute from the first stream of the solution at the initial phase.

At block 606, the method 600 includes processing, at the initial phase, the second stream of the solution by the HMX2 to generate the first concentrate stream of the solution at the state Rₒᵤₜ. The HMX2 includes the second desiccant which releases the second amount of the solute within the second stream of the solution at the initial phase. Further, at block 604, the method 600 includes directing, at the initial phase, the first dilute stream of the solution at the state Dₒᵤₜ from the processing unit to the HMX1-n of the successive processing unit 102-n from among the plurality of processing units 102. At block 608, the method 600 includes processing, at the initial phase, the first dilute stream of the solution by the HMX1-n of the successive processing unit to generate the concentrate stream of the solution at the state Rₒᵤₜ₋ₙ.

Referring to FIG. 6b, at block 610, the method 600 includes receiving the first stream of the solution at the state Dᵢₙ₋ₙ by the HMX2-n of the successive processing unit 102-n. Further, at block 612, the method 600 includes processing, at the initial phase, the first stream of the solution by the HMX2-n of the successive processing unit to generate the second dilute stream of the solution at the state Dₒᵤₜ₋ₙ. An amount of the solute within the second dilute stream of the solution at the state Dₒᵤₜ₋ₙ may be less than an amount of the solute within the first stream of the solution at the state Dᵢₙ.

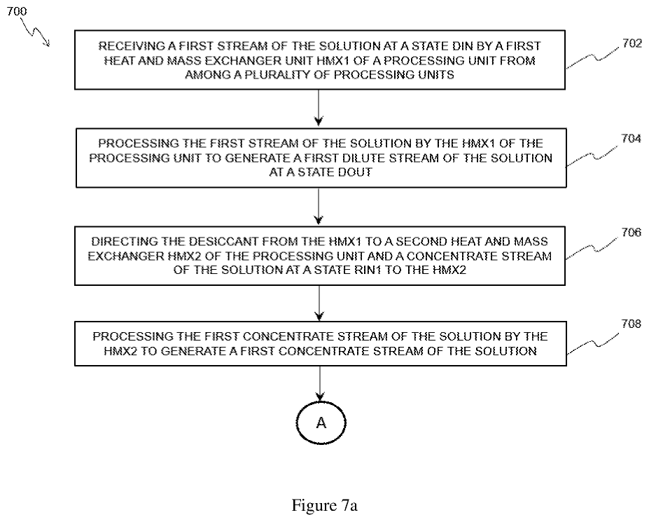

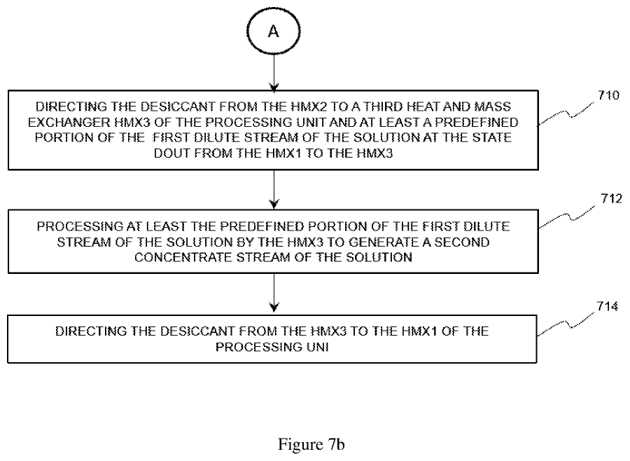

FIGS. 7a and 7b illustrates a flowchart depicting a method 600 for changing concentration of a solvent within a solution by diluting concentration of the solute within the solution, according to an embodiment of the present disclosure. For the sake of brevity, features of the system 100 that are already explained in detail in the description of FIG. 1, FIG. 2, FIG. 3, FIG. 4a, FIG. 4b, FIG. 4c, FIG. 4d, FIG. 5, FIG. 6a, and FIG. 6b are not explained in detail in the description of FIG. 7a and FIG. 7b.

Referring to FIG. 7a, at block 702, the method 700 includes receiving the first stream of the solution at the state Dᵢₙ by the HMX1 of the processing unit 102-1. Further, at block 704, the method includes processing the first stream of the solution by the HMX1 of the processing unit to generate the first dilute stream of the solution at the state Dₒᵤₜ. The HMX1 includes the desiccant which absorbs the first amount of the solute from the first stream of the solution.

At block 706, the method 700 includes directing the desiccant from the HMX1 to the HMX2 of the processing unit 102-1 and the concentrate stream of the solution at the state Rᵢₙ₁ to the HMX2. Further, at block 708, the method includes processing the first concentrate stream of the solution by the HMX2 to generate the first concentrate stream of the solution. The desiccant received by the HMX2 releases at least the first predefined amount of the solute which is being absorbed/adsorbed from the first stream of the solution in the HMX1.

Referring to FIG. 7b, at block 710, the method 700 includes directing the desiccant from the HMX2 to the HMX3 of the processing unit and at least the predefined portion of the first dilute stream of the solution at the state Dₒᵤₜ from the HMX1 to the HMX3. Further, at block 712, the method 700 includes processing at least the predefined portion of the first dilute stream of the solution by the HMX3 to generate the second concentrate stream of the solution. The desiccant received by the HMX3 from the HMX2 releases at least the second predefined amount of the solute which is being absorbed/adsorbed from the first stream of the solution in the HMX1. At block 714, the method includes directing the desiccant from the HMX3 to the HMX1 of the processing unit. The desiccant re-absorbs the second amount of the solute from another stream directed in the HMX1.

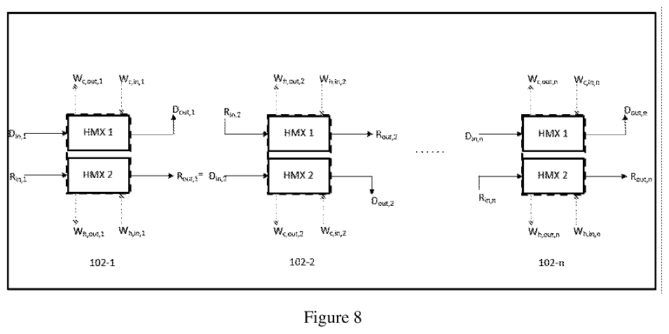

FIG. 8 illustrates the system implementing a method for changing concentration of a solvent within a solution by increasing concentration of the solute within the solution, according to an embodiment of the present disclosure. In an embodiment, the solute and the solution may be embodied as moisture and air, respectively, without departing from the scope of the present disclosure. In such an embodiment, a method of increasing concentration of the solute within the solvent may be referred to as humidification process.

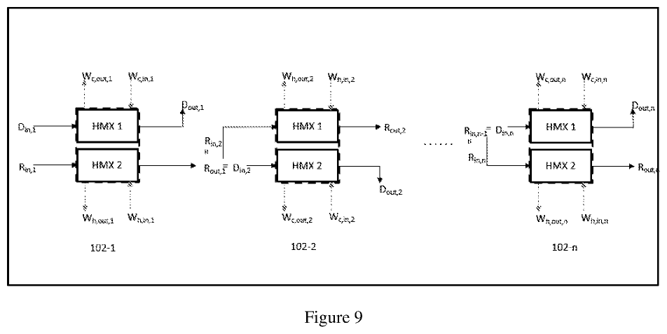

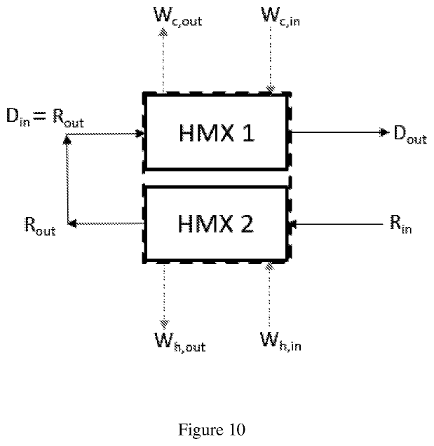

FIG. 8, FIG. 9, FIG. 10, and FIGS. 11a-11b of the present disclosure are explained with respect to humidification process. However, it should be appreciated by a person skilled in the art that the present disclosure is equally to other process for changing concentration of solutes within different types of solutions, without departing from the scope of the present disclosure.

The regeneration air-stream, after drying/regenerating the desiccant (while simultaneously getting heated in the process) during regeneration process, itself becomes humid. This humid air-stream is then used as the inlet air-stream for dehumidification process (which also involves simultaneous cooling or full/partial heat-rejection) during which the desiccant is charged/impregnated with moisture by adsorption/absorption process. While the dehumidified air-stream may be discarded off, the humid air-stream after two or more such cycles of the two processes (regeneration and dehumidification) in a single unit may be bled out and utilized as the useful product (either as the final product or intermediate product depending on the application) or else after two or more stages of the aforementioned process, is utilized as the useful product.

Referring to FIG. 8, in the illustrated embodiment, the HMX1 may be configured to receive the first stream of the solution at the state Dᵢₙ of the processing unit 102-1 from among the plurality of processing units 102. Further, the HMX2 the processing unit 102-1 may be configured to receive the second stream of the solution at the state Rᵢₙ, interchangeably referred to as Rᵢₙ. Upon receiving the first stream, the HMX1 may process, at the initial phase, the first stream of the solution to generate the first dilute stream of the solution at the state Dₒᵤₜ.

The HMX1 may include the first desiccant which absorbs the first amount of the solute from the first stream of the solution at the initial phase. The first desiccant may perform sorption, such as absorption and adsorption, of the solute from the first dilute stream, when the first stream of fluid at state W_{c,in,1} is directed to the HMX1. The first stream of fluid may absorb heat generated during sorption of the first amount of the solute from the first stream of the solution by the first desiccant. This ensures that the first dilute stream of the solution may not become hot at an outlet of the HMX1.

Subsequently, upon receiving the second stream, the HMX2 may process the second stream of the solution at the state Rᵢₙ to generate the first concentrate stream of the solution at the state Rₒᵤₜ. The HMX2 may include the second desiccant which releases the second amount of the solute within the second stream of the solution at the initial phase. In particular, the second stream of the solution may takes up the solute from the second desiccant, when the second stream of fluid at the state W_{h,in,1} is directed to the HMX2.

The second stream of fluid releases heat to increase temperature of the second desiccant which releases the second amount of the solute within the solvent. The second desiccant may perform sorption, such as absorption and adsorption, of the solute from the first dilute stream, when the first stream of fluid at state W_{c,in,1} is directed to the HMX1. The first stream of fluid may absorb heat generated during sorption of the first amount of the solute from the first stream of the solution by the first desiccant.

During humidification process, the first dilute stream at the state Dₒᵤₜ generated by the HMX1 may be discarded from the system 100. At the initial phase, the HMX2 of the processing unit 102-1 may be configured to supply the first concentrate stream of the solution at the state Rₒᵤₜ to the HMX2-n of a successive processing unit 102-n from among the plurality of the processing units 102. In the illustrated embodiment, the HMX2 may be configured to supply the first concentrate stream of the solution at the state Rₒᵤₜ to the HMX2-n, where n=2, of a successive processing unit 102-2, interchangeably referred as the processing unit 102-2. The first concentrate stream at the state Rₒᵤₜ may be directed to the HMX2-2 for using such stream as dehumidification stream, i.e., Dᵢₙ₋₂.

Subsequently, at the initial phase, the HMX2-2 may process the first concentrate stream of the solution at the state Dᵢₙ₋₂ to generate a dilute stream of the solution at a state Dₒᵤₜ₋₂. In the illustrated embodiment, the dilute stream at the state Dₒᵤₜ₋₂ generated by the HMX2-2 may be discarded from the system 100. Further, the first heat and mass exchanger HMX1-2 of the processing unit 102-2 may be configured to receive another stream, i.e., a second stream of the solution at a state Rᵢₙ₋₂.

Upon receiving the second stream at the state Rᵢₙ₋₂, the HMX1-2, at the initial phase, may process the second stream of the solution at the state Rᵢₙ₋₂ to generate a second concentrate stream of the solution at a state Rₒᵤₜ₋₂. In one embodiment, the second concentrate stream of the solution may be used as a final product of the system. In another embodiment, the second concentrate stream of the solution at state Rₒᵤₜ₋₂ may be directed to HMX of the subsequent processing unit 102-n, where n=3.

In the illustrated embodiment, the amount of the solute within the second concentrate stream of the solution at the state Rₒᵤₜ₋₂ may be higher than an amount of the solute within the second stream of the solution at the state Rᵢₙ₋₁. Also, the amount of solute within the second concentrate stream of the solution at the state Rₒᵤₜ₋₂ may be higher than an amount of the solute within the first concentrate stream of the solution at the state Rₒᵤₜ₋₁.

FIG. 9 illustrates the system implementing the method for changing concentration of the solvent within the solution by increasing concentration of the solute within the solution, according to an embodiment of the present disclosure. For the sake of brevity, features of the system 100 that are already explained in detail in the description of FIG. 1 and FIG. 8 are not explained in detail in the description of FIG. 9.

Referring to FIG. 9, in the illustrated embodiment, the HMX2 may supply at least a portion of the first concentrate stream at the state Rₒᵤₜ to the HMX1-n, where n=2, of the successive unit, i.e., the processing unit 102-2. Upon receiving at least the portion of the first concentrate stream, the HMX1-n may process the received portion to generate a concentrate stream, such as the second concentrate stream at the state Rₒᵤₜ₋₂. The second concentrate stream at the state Rₒᵤₜ₋₂ may further be directed to HMX1-n, where n=3, of subsequent processing unit, such as the processing unit 102-3.

FIG. 10 illustrates a block diagram of a processing unit of the system 100 implementing the method for changing concentration of the solvent within the solution by increasing concentration of the solute within the solution, according to an embodiment of the present disclosure. Details of the present embodiment are explained with respect to the HMX1 and the HMX2 of the processing unit 102-1.

However, it should be appreciated by a person skilled in the art that the present embodiment can equally be implemented with respect to other processing units 102 of the system 100, without departing from the scope of the present disclosure. For the sake of brevity, features of the system 100 that are already explained in detail in the description of FIG. 1, FIG. 8, and FIG. 9 are not explained in detail in the description of FIG. 10.

Referring to FIG. 10, in the illustrated embodiment, the heat and mass exchanger unit HMX2 may be configured to supply at least a portion of the first concentrate stream of the solution to the HMX1 of the processing unit 102-1. Subsequently, the HMX1 may process at least the portion of the first concentrate stream of the solution to generate a dilute stream of the solution at the state Dₒᵤₜ. In the illustrated embodiment, the dilute stream at the state Dₒᵤₜ may be discarded from the system 100. In one embodiment, the first concentrate stream at the state Rₒᵤₜ may partially, i.e., at least the portion of stream, used as a dehumidification stream, i.e., Dᵢₙ. In such an embodiment, remaining portion of the first concentrate stream may be utilized as a final product from the system 100.

In another embodiment, the first concentrate stream at the state Rₒᵤₜ may fully be used as the dehumidification stream, i.e., Dᵢₙ. In such an embodiment, the first concentrate stream at the state Rₒᵤₜ may fully be used as the dehumidification stream, until a periodically steady-state is achieved. However, when the periodically steady-state is achieved, the first concentrate stream at the state Rₒᵤₜ may partially be used as the dehumidification stream and remaining portion of the first concentrate stream may be used as the final product.

It may be noted that details regarding system and method for concentrating the solute within the solution are explained with respect to configurations as depicted in FIG. 8, FIG. 9, FIG. 10, FIG. 11a, and FIG. 11b. However, it should be appreciated by a person skilled in the art that such details can equally be implemented with respect to other configurations, without departing from the scope of the present disclosure.

Needless to say, all the possibilities regarding different configurations, details of the units, relative directions, magnitude and duration of air and water flow and a number of HMXs discussed with respect to dehumidification process also exist for humidification process.

FIG. 11a and Figure lib illustrate a flowchart depicting a method 1100 for changing concentration of the solvent within the solution by increasing concentration of the solute within the solution, according to an embodiment of the present disclosure. For the sake of brevity, features of the system 100 that are already explained in detail in the description of FIG. 1, FIG. 8, FIG. 9, and FIG. 10 are not explained in detail in the description of FIG. 11a and Figure lib.

Referring to FIG. 11a, at block 1102, the method 1100 includes receiving the first stream of the solution at the state Dᵢₙ by the HMX1 of the processing unit from among the plurality of processing units and the second stream of the solution at the state Rᵢₙ by the HMX2 of the processing unit. Further, at block 1104, the method 1100 includes processing the first stream of the solution by the HMX1 to generate the first dilute stream of the solution at the state Dₒᵤₜ. The HMX1 includes the first desiccant which absorbs the first amount of the solute from the first stream of the solution at the initial phase.

Further, at block 1106, the method includes processing, at the initial phase, the second stream of the solution by the HMX2 to generate the first concentrate stream of the solution at the state Rₒᵤₜ. The HMX2 includes the second desiccant which releases the second amount of the solute within the second stream of the solution at the initial phase. At block 1108, the method includes directing, at the initial phase, the first concentrate stream of the solution at the state Rₒᵤₜ from the processing unit to the HMX2-n of the successive processing unit from among the plurality of processing units.

Referring to FIG. 10b, at block 1110, the method 1100 includes processing, at the initial phase, the first concentrate stream of the solution by the HMX2-n of the successive processing unit to generate the dilute stream of the solution at the state Dₒᵤₜ₋ₙ. Further, at block 1112, the method 1100 includes receiving the first stream of the solution at the state Rᵢₙ₋ₙ by the HMX1-n of the successive processing unit. At block 1114, the method includes processing, at the initial phase, the concentrate stream of the solution by the HMX2-n of the successive processing unit to generate the second concentrate stream of the solution at the state Rₒᵤₜ₋ₙ. An amount of the solute within the second concentrate stream of the solution at the state Rₒᵤₜ₋ₙ may be higher than an amount of the solute within the second stream of the solution at the state Rₒᵤₜ.

### Mathematical Model

The mathematical model used herein is for simulating the performance of a DCFTHX (desiccant coated fin tube heat exchanger) for counter-flow arrangement of air-streams. It is similar to that presented in the Journal: Jagirdar M and Lee P S, Mathematical modeling and performance evaluation of a desiccant coated fin-tube heat exchanger. Applied Energy, 2018). The mathematical model as disclosed in the aforementioned journal is slightly altered in cognizance of the method(s) as explained in the present disclosure. The mathematical model implemented herein uses the inlet boundary condition (of air) to a unit, such as the HMX, undergoing regeneration for a case of the dehumidification process as given by equation (1). Note that this condition is applied to configuration similar to that of FIG. 4(a) wherein the desired end-product is dehumidified air.

$${Y}_{a} ( {L}_{x} , z , t ) = {Y}_{a} ( {L}_{x} , z , t - {t}_{1} ) ; {t}_{1} \leq t < {t}_{1} + {t}_{2} , \frac{{H}_{f}}{2} + {H}_{d} < z \leq \frac{{H}_{f}}{2} + {H}_{d} + \frac{{H}_{a}}{2} \qquad ( 1 )$$

While for the unit, such as the HMX, undergoing dehumidification for the regeneration process is given by equation (2). Note that this condition is applied to configuration similar to that of FIG. 10 wherein the desired end-product is humidified air.

$${Y}_{a} ( 0 , z , t ) = {Y}_{a} ( 0 , z , t + {t}_{1} ) ; 0 \leq t < {t}_{1} , \frac{{H}_{f}}{2} + {H}_{d} < z \leq \frac{{H}_{f}}{2} + {H}_{d} + \frac{{H}_{a}}{2} \qquad ( 2 )$$

Here, Ya(Lx,z,t) is the specific-humidity of air at the inlet (x=Lx) of the DCFTHX that regenerates air, at location ‘z’ in the direction transverse to the air-flow (along the height of the air channel) at time ‘t’. t1 and t2 are the durations of dehumidification and regeneration processes respectively. Hf, Hd and Ha are respectively the thickness of the fins, the desiccant layer thickness and height of the air channel.

### Experimental Data

The variables selected to conduct the simulations are as presented in Table 1 for dehumidification process and humidification process, unless otherwise stated. It should be appreciated by a person skilled in the art that Table 1 is included to provide a better understanding of the present disclosure and therefore, should not be construed as limiting.

TABLE 1
Input data for simulations
Desiccant properties

| | | | | | | | |
|---|---|---|---|---|---|---|---|
| Desiccant | 800 | kg/m³ | mass fraction | 0.9 | specific heat | 921 | J/(Kg-K) |

| density | | of sorbent | | | of desiccant |
|---|---|---|---|---|---|
| Desiccant | 0.3 | Pore diameter | 10 | nm | |

porosity

Geometrical parameters of DCFTHX

| longitudinal | 22 | mm | tube length | 600 | mm | Desiccant thickness | 0.15 | mm |
|---|---|---|---|---|---|---|---|---|
| tube pitch | | | (height of HX) | | | | | |
| transverse | 25.4 | mm | Inner tube | 8.5 | mm | Fin thickness | 0.1 | mm |
| tube pitch | | | diameter | | | | | |
| length of | 44 | mm | Outer tube | 9.5 | mm | | | |
| the fin | | | diameter | | | | | |
| width of | 304.8 | mm | Fin pitch | 2 | mm | | | |

the fin

Fluid flow conditions for dehumidification cases

| dehumidification | 120 | s | Inlet temperature | 30° | C. | Inlet specific | 0.0197 | kg/kg |
|---|---|---|---|---|---|---|---|---|
| time period | | | of (cool) water | | | humidity of working | d.a. | |
| | | | during | | | air during | | |
| | | | dehumidification | | | dehumidification | | |
| regeneration | 120 | s | Inlet temperature | 40° | C. | Inlet specific | 0.0197 | kg/kg |
| time period | | | of (hot) water | | | humidity of working | d.a. | |
| | | | during | | | air during | | |
| | | | regeneration | | | regeneration | | |
| Mass flow rate | 4 | kg/s | Inlet temperature | 32° | C. | | | |
| of hot water | | | of working air | | | | | |
| | | | during | | | | | |
| | | | dehumidification | | | | | |
| Mass flow rate | 4 | kg/s | Inlet temperature | 32° | C. | | | |

| | |
|---|---|
| of cool water | of working air |
| | during |
| | regeneration |

Fluid flow conditions for simulations of humidification cases

| dehumidification | Variable | | Inlet temperature | 15° | C. | Inlet specific | 0.0032 | kg/kg |
|---|---|---|---|---|---|---|---|---|
| time period | | | of (cool) water | | | humidity of working | d.a. | |
| | | | during | | | air during | | |
| | | | dehumidification | | | dehumidification | | |
| regeneration | Variable | | Inlet temperature | 25° | C. | Inlet specific | 0.0032 | kg/kg |
| time period | | | of (hot) water | | | humidity of working | d.a. | |
| | | | during | | | air during | | |
| | | | regeneration | | | regeneration | | |
| Mass flow rate | 4 | kg/s | Inlet temperature | 15° | C. | | | |
| of hot water | | | of working air | | | | | |
| | | | during | | | | | |
| | | | dehumidification | | | | | |
| Mass flow rate | 4 | kg/s | Inlet temperature | 15° | C. | | | |

| | |
|---|---|
| of cool water | of working air |
| | during |
| | dehumidification |

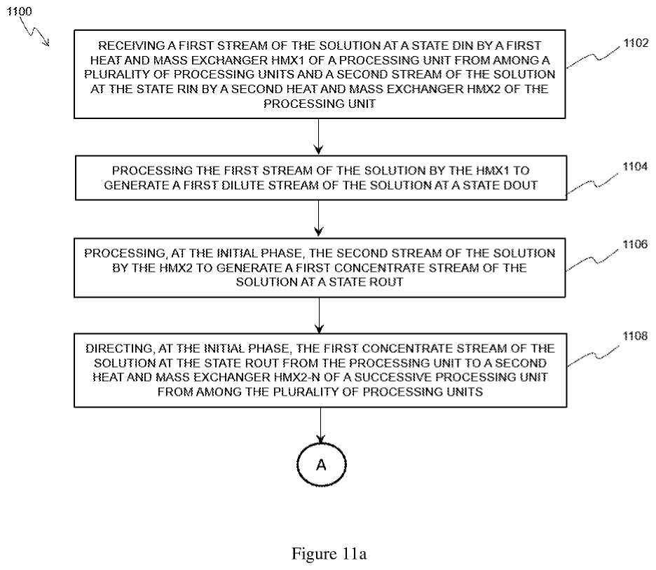

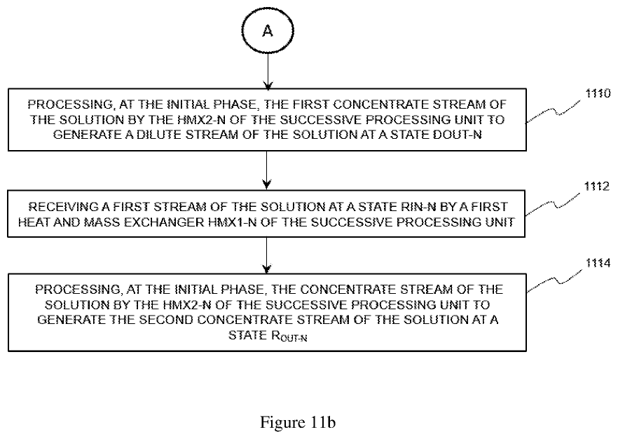

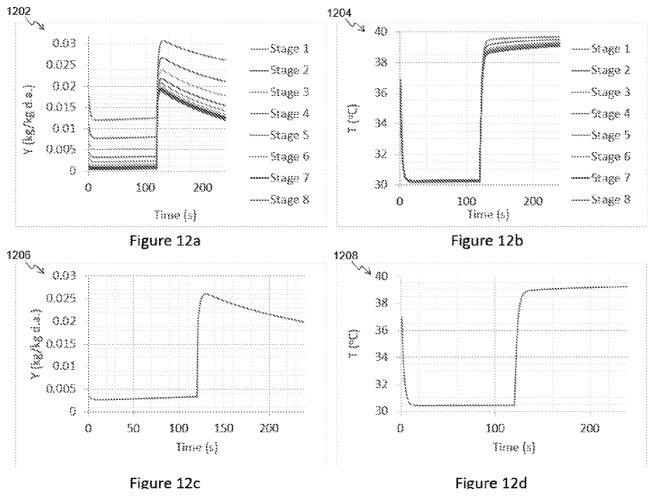

FIG. 12a and FIG. 12b illustrates graphical plots 1202, 1204 depicting variation in specific humidity and temperature of the solution with respect to time duration, according to an embodiment of the present disclosure. The graphical plots depict variation in the specific humidity and the temperature of the solution for configuration as explained in FIG. 1. For experimental purpose, n=12 (that is 12 Units or 12 stages) and air-flow velocity of 0.759 m/s are considered for both the dehumidification as well as regeneration air-streams in counter-flow configuration.

It may be clearly observed in FIG. 12a that although inlet specific humidity Ya,in,de is high (0.0197 kg/kg d.a), the outlet specific humidity during dehumidification (from 0 to 120 seconds) is low. While going from one stage to the next, the outlet specific humidity reduces and after Stage 12, ultra-low specific humidity of 0.000481 kg/kg d.a (time-averaged value for the duration of dehumidification 0-120 seconds) is realized. This is unprecedented for a temperature swing of just 10° C. (between hot and cool water streams). Further, as shown in FIG. 12b, a temperature of the outlet dehumidified air for all stages approaches to the cool water temperature of 30° C.

FIG. 12c and FIG. 12d illustrates graphical plots 1206, 1208 depicting variation in specific humidity and temperature of the solution with respect to time duration, according to an embodiment of the present disclosure. The graphical plots depict variation in the specific humidity and the temperature of the solution for configuration as explained in FIG. 4a. For experimental purpose, air-flow velocity of dehumidification air, i.e., Dᵢₙ, is considered as 0.759 m/s and air-flow velocity of regeneration air, i.e., Rᵢₙ, is considered as 0.683 m/s. It should be understood that difference in these velocities is because of bleeding out some of the dehumidified air to be used as the useful product.

It may be clearly observed in FIG. 12c that despite the inlet specific humidity Ya,in,de being high (0.0197 kg/kg d.a), the outlet specific humidity during dehumidification (from 0 to 120 seconds) is low (the time-averaged value of the outlet specific humidity being 0.00297 kg/kg d.a. during dehumidification time-period from 0 to 120 seconds). Further, as shown in FIG. 12d, the temperature of the outlet dehumidified air approaches the cool water temperature of 30° C. during dehumidification time-period.

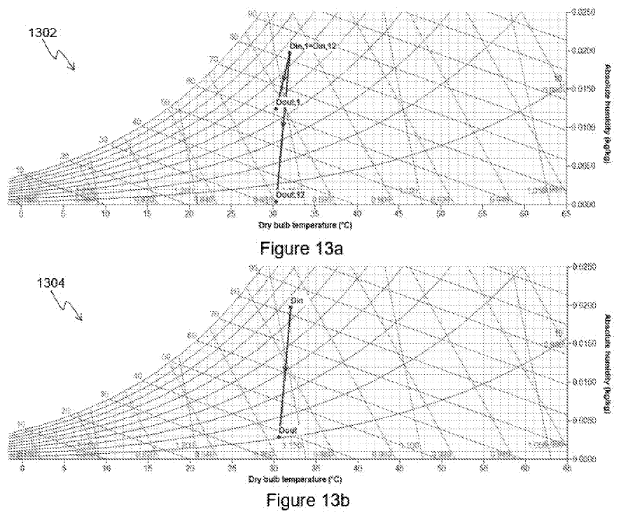

FIG. 13a illustrates a psychometric plot 1302 depicting time-averaged air-states corresponding to the solution entering a first processing unit 102-4 and exiting from a last processing unit 102-n of the system, according to an embodiment of the present disclosure. In particular, the psychometric plot depicts time-averaged air-states corresponding to dehumidification air-stream at the inlet and outlet of Unit/Stage 1, i.e., the processing unit 102-1 and Unit/Stage 12, i.e., the processing unit 102-12, respectively.

FIG. 13b illustrates a psychometric plot 1304 depicting time-averaged air-states corresponding to the solution entering a processing unit, according to an embodiment of the present disclosure. In particular, the psychometric plot depicts time-averaged air-states corresponding to dehumidification air-stream at inlet and outlet of the processing unit 102-1 which is explained in FIG. 4a.

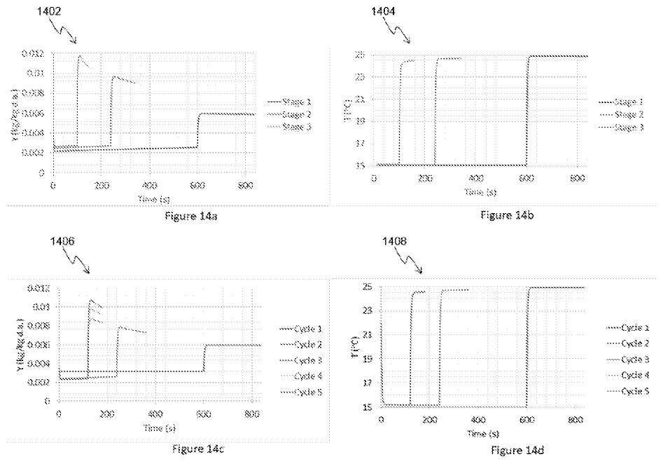

FIG. 14a and FIG. 14b illustrate graphical plots 1402, 1404 depicting variation in specific humidity and temperature of the solution with respect to time duration, according to an embodiment of the present disclosure. The graphical plots depict variation in the specific humidity and the temperature of the solution for configuration as explained in FIG. 1. For experimental purpose, n=3 (that is 3 Units or 3 stages) and air-flow velocity of 0.759 m/s are considered for both the dehumidification as well as regeneration air-streams in counter-flow configuration.

It may be clearly observed in FIG. 14a that although inlet specific humidity Ya,in,de is low (0.0032 kg/kg d.a), the outlet specific humidity during humidification is high. While going from one stage to the next, the outlet specific humidity increases and after Stage 3, the specific humidity of 0.011 kg/kg d.a (time-averaged value for the duration of humidification 100-160 seconds) is realized. Note here that t1 and t2 are variable here. This is unprecedented for a temperature swing of just 10° C. (between hot and cool water streams). Further, as shown in FIG. 14b, a temperature of the outlet humidified air for all stages approaches the relatively hot water temperature of 25° C.

FIG. 14c and FIG. 14d illustrate graphical plots 1406, 1408 depicting variation in specific humidity and temperature of the solution with respect to time duration, according to an embodiment of the present disclosure. The graphical plots depict variation in the specific humidity and the temperature of the solution for configuration as explained in FIG. 10. It may be clearly observed in FIG. 14a that although inlet specific humidity Ya,in,de is low (0.0032 kg/kg d.a), the outlet specific humidity during humidification is high, the numeric value being 0.0103 kg/kg d.a (time-averaged value for the duration of humidification 120-180 seconds) for cycle 5. Note here that t1 and t2 are different here and vary from one cycle to the next. This is unprecedented for a temperature swing of just 10° C. (between hot and cool water streams). As seen in FIG. 14b, the temperature of the outlet humidified air for all stages approaches the relatively hot water temperature of 25° C.

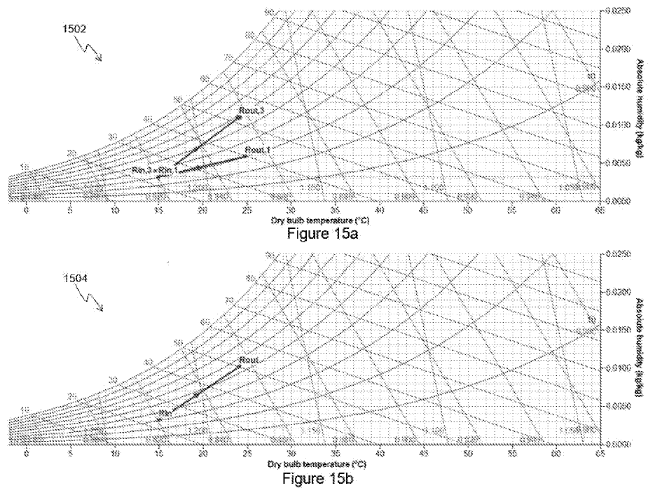

FIG. 15a illustrates a psychometric plot 1502 depicting time-averaged air-states corresponding to the solution entering a first processing unit 102-4 and exiting from a last processing unit 102-n of the system, according to an embodiment of the present disclosure. The psychometric plot depicts time-averaged air-states corresponding to dehumidification air-stream in configuration as shown in FIG. 8 of the present disclosure. In particular, the psychometric plot depicts time-averaged air-states corresponding to dehumidification air-stream at the inlet and outlet of Unit/Stage 1, i.e., the processing unit 102-1 and Unit/Stage 3, i.e., the processing unit 102-3, respectively.

FIG. 15b illustrates a psychometric plot 1504 depicting time-averaged air-states corresponding to the solution entering a processing unit, according to an embodiment of the present disclosure. In particular, the psychometric plot depicts time-averaged air-states corresponding to humidification air-stream at inlet and outlet of the processing unit 102-1 which is explained in FIG. 10.

The method(s) implemented in configurations depicted in FIG. 2 and FIG. 4a for dehumidifying air has been conclusively shown to work exceedingly well in terms of reduction of specific humidity achieved for a small temperature differential between the heating and cooling fluid (water in this case). Out of a number of possible configurations that confirm to the novel method for dehumidification, two configurations were tested, one having multiple stages while the other involving redirecting dehumidified air for regeneration, in the same unit. The product air at the outlet of the tested configurations had humidity of ˜0.0005 kg/kg d.a. and ˜0.003 kg/kg d.a. respectively when the inlet air humidity was 0.0197 kg/kg d.a.

The method(s) implemented in configurations depicted in FIG. 8 and FIG. 10 for humidifying air too has been conclusively shown to work exceedingly well. The achievable specific humidity is very high. In fact, using this method, the relative humidity can theoretically reach saturation (100%) even for a small temperature differential between the heating and cooling fluids (water in this case). Out of a number of possible configurations that confirm to the novel method for humidification, two configurations were tested, one having multiple stages while the other involving redirecting humidified air for dehumidification, in the same unit. The product air at the outlet of the tested configurations had humidity of 0.011 kg/kg d.a. and 0.0103 kg/kg d.a. respectively when the inlet specific humidity was 0.0032 kg/kg d.a.

The method(s) which are explained in the present disclosure can be employed in various applications including, but not limited to, desalination, water-distillation as well as for humidifiers that may also be used in power-plants, industries etc, Therefore, the method(s) of the present disclosure has a wide range of applications.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

We claim:

1. The method for changing concentration of a solute within a solution, the method comprising:
receiving a first stream of the solution at a state Dᵢₙ by a first heat and mass exchanger HMX1 of a processing unit from among a plurality of processing units and a second stream of the solution at the state Rᵢₙ by a second heat and mass exchanger HMX2 of the processing unit;
processing the first stream of the solution by the HMX1 to generate a first dilute stream of the solution at a state Dₒᵤₜ, wherein the HMX1 includes a first desiccant which absorbs a first amount of the solute from the first stream of the solution at an initial phase;
to processing, at the initial phase, the second stream of the solution by the HMX2 to generate a first concentrate stream of the solution at a state Rₒᵤₜ, wherein the HMX2 includes a second desiccant which releases a second amount of the solute within the second stream of the solution at the initial phase;
directing, at the initial phase, the first dilute stream of the solution at the state Dₒᵤₜ from the processing unit to a first heat and mass exchanger HMX1-n of a successive processing unit from among the plurality of processing units;
processing, at the initial phase, the first dilute stream of the solution by the HMX1-n of the successive processing unit to generate a concentrate stream of the solution at a state Rₒᵤₜ₋ₙ;
receiving a first stream of the solution at a state Dᵢₙ₋ₙ by a second heat and mass exchanger HMX2-n of the successive processing unit; and
processing, at the initial phase, the first stream of the solution by the HMX2-n of the successive processing unit to generate a second dilute stream of the solution at a state Dₒᵤₜ₋ₙ, wherein an amount of the solute within the second dilute stream of the solution at the state Dₒᵤₜ₋ₙ is less than an amount of the solute within the first stream of the solution at the state Dᵢₙ.

2. The method as claimed in claim 1, wherein at the subsequent phase, interchanging of operation of the HMX1-n and HMX2-n comprising:
directing the first dilute stream of the solution at the state Dₒᵤₜ to the HMX2-n of the successive processing unit;
processing the first dilute stream of the solution by the HMX2-n to generate the concentrate stream of the solution at the state Rₒᵤₜ₋ₙ, wherein the HMX2-n includes a desiccant adapted to release at least a portion from the solute which is being absorbed/adsorbed during the initial phase;
receiving the first stream of the solution at the state Dᵢₙ₋ₙ by the HMX1-n of the successive processing unit; and
processing the second concentrate stream of the solution by the HMX1-n to generate the second dilute stream of the solution at the state Dₒᵤₜ₋ₙ, wherein the HMX1-n includes a desiccant adapted to re-absorb an amount the solute to generate the second dilute stream of the solution.

3. The method as claimed in claim 1 further comprising:
directing, at the initial phase, at least a portion of the first dilute stream of the solution from the HMX1 of the processing unit to the HMX2-n of the successive processing unit; and
processing at least the portion of the first dilute stream by the HMX2-n to generate the second dilute stream at the state Dₒᵤₜ₋ₙ.

4. The method as claimed in claim 1 further comprising:
directing at least a portion of the first dilute stream at the state Dₒᵤₜ of the solution to a third heat and mass exchanger HMX3 of the processing unit; and
processing the at least the portion of the first dilute stream of the solution by the HMX3 of the processing unit to generate a concentrate stream of the solution at a state Rₒᵤₜ.

5. The method as claimed in claim 1 further comprising:
directing a first stream of fluid at a state W_{c,in,1} to the HMX1, wherein the first stream of fluid absorbs heat generated during absorption of the first amount of the solute from the first stream of the solution by the first desiccant; and
directing a second stream of fluid at a state W_{h,in,1} to the HMX2, wherein the second stream of fluid releases heat to increase temperature of the second desiccant which releases the second amount of the solute within the solvent.

6. The method as claimed in claim 1 further comprising:
directing a first stream of water at a state W_{c,in,n} to the HMX1-n, wherein the first stream of water absorbs heat generated during absorption of the first amount of the solute from the first stream of the solution; and
directing a second stream of water at a state W_{h,in,n} to the HMX2-n, wherein the second stream of water releases heat to increase temperature of the second desiccant which releases the second amount of the solute within the solvent.

7. The method as claimed in claim 1, wherein each of the first desiccant and the second desiccant is one of a liquid desiccant, a solid desiccant, and pellets of solid desiccant.

8. A method for changing concentration of a solute within a solvent, the method comprising:
receiving a first stream of the solution at a state Dᵢₙ by a first heat and mass exchanger HMX1 of a processing unit;
processing the first stream of the solution by the HMX1 to generate a first dilute stream of the solution at a state Dₒᵤₜ, wherein the HMX1 includes a first desiccant which absorbs a first amount of the solute from the first stream of the solution at an initial phase;
directing, at the initial phase, at least a portion of the first dilute stream of the solution from the HMX1 to a second heat and mass exchanger HMX2 of the processing unit; and
processing, by the HMX2, at least the portion of the first dilute stream to generate a concentrate stream of the solution at a state Rₒᵤₜ.

9. The method as claimed in claim 8 further comprising:
directing, for a first time duration, the first stream of the solution at the state Dᵢₙ to the HMX2;
processing the first stream of the solution at the state Dᵢₙ to generate a first concentrate stream of the solution at the state Rₒᵤₜ;
directing, for a second time duration subsequent to the first time duration, at least a portion of the first dilute stream of the solution at the state Dₒᵤₜ from the HMX1 to the HMX2; and
processing at least the portion of the first dilute stream of the solution by the HMX2 to generate a concentrate stream of the solution at a state Rₒᵤₜ.

10. The method as claimed in claim 9 further comprising:
directing the concentrate stream of the solution at the state Rₒᵤₜ from the HMX2 to the HMX1; and
processing the concentrate stream of the solution by the HMX1 to generate the first dilute stream of the solution at the state Dₒᵤₜ.

11. The method for changing concentration of a solute within a solution, the method comprising:
receiving a first stream of the solution at a state Dᵢₙ by a first heat and mass exchanger HMX1 of a processing unit from among a plurality of processing units and a second stream of the solution at the state Rᵢₙ by a second heat and mass exchanger HMX2 of the processing unit;
processing the first stream of the solution by the HMX1 to generate a first dilute stream of the solution at a state Dₒᵤₜ, wherein the HMX1 includes a first desiccant which absorbs a first amount of the solute from the first stream of the solution at an initial phase;
processing, at the initial phase, the second stream of the solution by the HMX2 to generate a first concentrate stream of the solution at a state Rₒᵤₜ, wherein the HMX2 includes a second desiccant which releases a second amount of the solute within the second stream of the solution at the initial phase;
directing, at the initial phase, the first concentrate stream of the solution at the state Rₒᵤₜ from the processing unit to a second heat and mass exchanger HMX2-n of a successive processing unit from among the plurality of processing units;
processing, at the initial phase, the first concentrate stream of the solution by the HMX2-n of the successive processing unit to generate a dilute stream of the solution at a state Dₒᵤₜ₋ₙ;
receiving a first stream of the solution at a state Rᵢₙ₋ₙ by a first heat and mass exchanger HMX1-n of the successive processing unit; and
processing, at the initial phase, the concentrate stream of the solution by the HMX2-n of the successive processing unit to generate the second concentrate stream of the solution at a state Rₒᵤₜ₋ₙ, wherein an amount of the solute within the second concentrate stream of the solution at the state Rₒᵤₜ₋ₙ is higher than an amount of the solute within the second stream of the solution at the state Rₒᵤₜ.

12. The method as claimed in claim 11, wherein, at a subsequent phase, operation of the HMX1-n and the HXM2-n of the subsequent processing unit is interchanged with each other.

13. The method as claimed in claim 11, wherein each of the first desiccant and the second desiccant is one of a liquid desiccant, a solid desiccant, and pellets of solid desiccant.

14. The method as claimed in claim 11 further comprising:
directing, at the initial phase, a first concentrate stream of the solution at the state Rᵢₙ to the HMX2 of the processing unit;
processing the first concentrate stream of the solution at the state Rᵢₙ by the HMX2 to generate a second concentrate stream of the solution at the state Rₒᵤₜ;
directing at least a portion of the second concentrate stream of the solution to the HMX1 of the processing unit; and
processing at least the portion of the second concentrate stream of the solution by the HMX1 to generate a dilute stream of the solution at the state Dₒᵤₜ.

15. The method as claimed in claim 11 further comprising:
directing, at the initial phase, at least a portion of the first concentrate stream of the solvent at the state Rₒᵤₜ from the HMX2 to the HMX1-n; and
processing at least the portion of the first concentrate stream of the solvent to generate a concentrate stream of the solvent at a state Rₒᵤₜ₋ₙ.

16. The method for changing concentration of a solute within a solution, the method comprising:
receiving a first stream of the solution at a state Dᵢₙ by a first heat and mass exchanger unit HMX1 of a processing unit from among a plurality of processing units;
processing the first stream of the solution by the HMX1 of the processing unit to generate a first dilute stream of the solution at a state Dₒᵤₜ, wherein the HMX1 includes a desiccant which absorbs a first predefined amount of the solute from the first stream of the solution;
directing the desiccant from the HMX1 to a second heat and mass exchanger HMX2 of the processing unit and a concentrate stream of the solution at a state Rᵢₙ₁ to the HMX2;
processing the first concentrate stream of the solution by the HMX2 to generate a first concentrate stream of the solution, wherein the desiccant received by the HMX2 releases at least the first predefined amount of the solute which is being absorbed/adsorbed from the first stream of the solution in the HMX1;
directing the desiccant from the HMX2 to a third heat and mass exchanger HMX3 of the processing unit and at least a portion of the first dilute stream of the solution at the state Dₒᵤₜ from the HMX1 to the HMX3;
processing at least the portion of the first dilute stream of the solution by the HMX3 to generate a second concentrate stream of the solution, wherein the desiccant received by the HMX3 from the HMX2 releases at least a second predefined amount of the solute which is being absorbed/adsorbed from the first stream of the solution in the HMX1; and
directing the desiccant from the HMX3 to the HMX1 of the processing unit, wherein the desiccant re-absorbs a second amount of the solute from another stream directed in the HMX1.

17. The method as claimed in claim 16, wherein the desiccant is one of a liquid desiccant and pellets of solid desiccant
